(19) United States
(12) Patent Application Publication
(10) Pub. No.: US 2011/0247065 A1
(43) Pub. Date: Oct. 6, 2011

(54) SIMULTANEOUS SCREEN UNLOCK AND OPERATION INITIATION

(76) Inventor: Volodymyr Melnyk, Bayonne, NJ (US)

(21) Appl. No.: 13/047,358

(22) Filed: Mar. 14, 2011

(51) Int. Cl. H04L 9/32

(52) U.S. Cl. 726/16

(57) ABSTRACT

An electronic device such as a smart phone or personal computer, adapted to both unlock and to execute at least one step of a standard operation such as placing a telephone call, responsive to the user executing only one input command The input command may comprise moving a slider on a touch screen, entering a predetermined combination of alphanumeric characters, and the like. The input command may also comprise hand drawing a symbol on the screen, whereupon the electronic device will execute a matching procedure similar to character recognition to authenticate the symbol. Authentication may then unlock the device and execute the at least one step of the standard operation.

### FIELD OF THE INVENTION

The present invention relates to electronic devices having display screens, and more particularly to an operating protocol which both unlocks the screen and makes progress towards device operation with as few as one manual user input command.

### BACKGROUND OF THE INVENTION

Electronic devices having display screens, such as mobile telephones having touch screens, are typically provided with hard locks or virtual locks or both for restricting unauthorized or unintended use. A hard lock may be a switch for example. A virtual lock may demand a user action performed on the screen, such as dragging a virtual slider to a predetermined point on the screen, entering a code such as an alphanumeric code, or drawing a predetermined form or image on the screen. Appropriate user action unlocks the screen, or alternatively stated, enables ordinary function to proceed.

In most cases, a user picks up the device with a specific purpose in mind. With electronic devices such as mobile telephones, such a purpose is typically to place a telephone call, which may be in audible or text format. In conventional practice, the user first unlocks the device, then performs additional steps requiring the user to enter predetermined commands to invoke the desired function. Illustratively, the user may open a virtual telephone book or like directory by depressing one switch button, may search for a particular party or contact the user wishes to contact by operating a scrolling control, may activate appropriate contact information, such as entering a telephone number into an activation mode by depressing still another key button, thereby ultimately placing the desired telephone call.

Each of these three exemplary actions requires a specific manual input from the user. The sum total of these actions can become cumbersome and may be susceptible to introducing errors which force the user to start the procedure again. For example, should navigating through screen options require pressing relatively small real or hard keys or switch pushbuttons, or virtual keys of a touch screen keyboard, it is possible to active an unintended key, thus defeating progress made up to that point.

The field of electronic devices remains in need of a more expeditious way of facilitating completion of those standard operations that are possible for each type of electronic device.

### SUMMARY OF THE INVENTION

The present invention provides an expedited procedure for unlocking a locked screen and simultaneously progressing towards completion of a task, where a task will be understood to be a standard operation of that electronic device. This may be implemented by establishing a predetermined action, such as manipulating an icon such as a slider, entering one or more hand drawn symbols on a touch screen, by establishing a procedure utilizing standard controls such as pushbuttons, which may also be operated in an arbitrary, previously unused way, or by establishing any personalized input procedure that is other than a control procedure which is standard or recognized by the system prior to programming by the user.

In the present invention, performing the selected input procedure both unlocks the screen and also activates at least one subsequent step in implementing a standard operation of the device. For example, where the task is that of placing a telephone call, entry of a selected input may not only unlock a locked screen, but may also open a virtual telephone directory. Optionally, entry of the selected personalized input may perform a still further subsequent operation, such as moving a cursor to a predetermined location within the list presented as part of the virtual telephone directory. In an exemplary implementation, performing the unlocking action may not only unlock the screen, but may also display dialing options from the virtual telephone directory.

Hence what formerly required perhaps three or more discrete actions by the user in this example is now accomplished in one action. The user is more quickly advanced towards completion of the selected task. Simultaneously, opportunities for introducing errors, such as misdialing or touching an adjacent command area on the screen and thereby activating an unintended function, are defeated.

It is an object of the invention to expedite the process of performing a task on an electronic device having a locking screen.

Another object of the invention is to enable a user to selectable a procedure for unlocking the screen and commencing performing of a task.

It is an object of the invention to provide improved elements and arrangements thereof by apparatus for the purposes described which is inexpensive, dependable, and fully effective in accomplishing the intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front view of a smart phone adapted according to at least one aspect of the invention.

FIG. 2 is a perspective view of a laptop computer adapted according to at least one aspect of the invention.

FIG. 3 is an exemplary image of a locked screen which may apply to the smart phone of FIG. 1.

FIG. 4 is a depiction of the screen of FIG. 3, at a time when it is being used for programming the associated electronic device.

FIG. 5 is a depiction of the screen of FIG. 3, showing exemplary content which may be displayed after a screen unlocking action has been performed.

FIG. 6 is shows exemplary content of the screen of FIG. 3, but with a variation showing additional, unprogrammed screen unlocking operators.

FIG. 7 is a view of a screen displaying virtual keys as opposed to the optional sliders seen in FIG. 6.

FIG. 8 is a view of the screen of FIG. 5, but showing prompts which may be displayed responsively to using a screen unlock operator.

FIG. 9 is a view of the screen of FIG. 4, but shows prompts which may be displayed responsively to failure of an image recognition feature to successfully identify an image drawn on the screen.

### DETAILED DESCRIPTION

The present invention sets forth an electronic device which processes data in the performance of a task. For the purposes of the present invention, a task is an operation in which data is processed to arrive at a desired goal, with the electronic device being a tool or implement to further implementation of the task. Examples of tasks include performing calculations, conducting or facilitating remote communications, retrieving and presenting information in user readable form, GPS navigation, and other operations which may be conducted by electronic telephones, personal digital assistants, computers, and like devices. A task may be thought of as an operation which the subject electronic device has been conceived. A task may be likened to a software application for example. In the example of data processing, the task could be regarded as generating a new document. Of course, it will be acknowledged that there are nonetheless variations in the scope of a task such as generating a new document, such as revising an existing document. However, for the purposes of this invention, a task is not intended to signify relatively minor operations such as utilizing a “delete” function to delete an unintended letter or word in the course of data processing. In a task, the user of the electronic device enters commands or enters, retrieves, or manipulates data or both to perform the task.

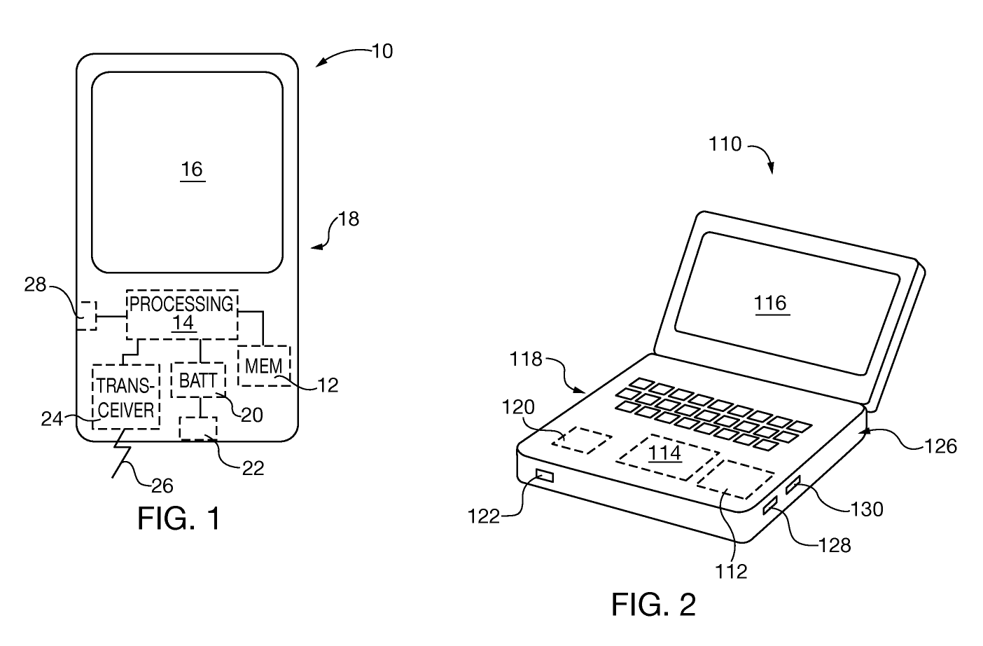

Referring now to FIG. 1, in one implementation of the invention, the electronic device may comprise a smart phone 10, which may comprise data handling apparatus including a memory device 12, a data processor 14, a display screen 16 disposed to present imagery thereon and which is controlled by the data handling apparatus, and a user interface such as real or virtual operating switches, all supported on or in a housing 18. The user interface is usable by a user to enter commands or data or both to the data handling apparatus.

The smart phone 10 may have a power source such as a battery 20, which may be rechargeable, a power port 22 for connection to a separate DC power supply (not shown), or both. The smart phone 10 may include a transceiver 24 for enabling wireless communication, represented as a radio signal 26, with communications networks (not shown). The transceiver 24 may of course comprise separate transmitter and receiver (not shown). The smart phone 10 may include a data port 28, for example of the type compatible with a USB (universal service bus) cable.

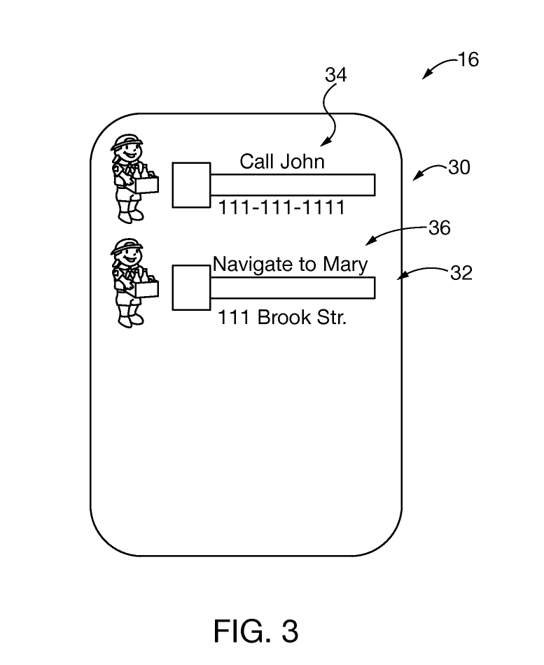

The screen 16 may be a touch screen, including virtual keys or operating pushbuttons that are adapted to accept commands and data inputs to the data handling apparatus. As will be explained further with regard to FIG. 3, wherein the screen 16 comprises a touch screen, it will be appreciated that the electronic device further comprises computer instructions loaded into the data handling apparatus, disposed to accept manual inputs established by making contact with the display screen 16. Hence where the display screen 16 comprises a touch screen, the touch screen both displays imagery generated by the electronic device and also serves as the user input interface.

The electronic device may be other than the smart phone 10. The electronic device may take the form of any hand held or portable or mobile communications device such as a personal digital assistant, or a device primarily intended as a data processor, including portable computing devices such as tablets, notebooks, laptop computers, and even stationary computers such as desktops.

FIG. 2 illustrates an example of a data processing form of electronic device which is capable of processing data and performing at least one task. The electronic device may take the form of a laptop computer 110 comprising data handling apparatus including memory 112 and a data processor 114, a display screen 116 which is the functional equivalent of the display screen 16, and a user input interface 126 usable by a user to enter at least one of commands and data to the data handling apparatus.

As illustrated in the example of FIG. 2, the user input interface 126 may comprise a plurality of switches which are depicted as pushbuttons, which would be that portion of each switch visible to the user outside the housing 118 of the laptop computer 110. Of course, the user interface 126 may comprise controls other than or in addition to pushbutton operated switches, such as rotary dial controls, rocker switches, slidable operator switches, toggle operated switches, and others, in any combination. Even beyond these examples, the user input interface 126 may comprise any device or apparatus which is disposed to accept inputs from a person using the laptop computer 110, and to communicate the inputs to the data handling apparatus for use with or by any of the various computer instructions which may be loaded into the data handling apparatus.

The laptop computer 110 may have a suitable power supply 120 which may comprise an AC to DC converter with or without a power cord, and with or without a battery connected thereto. As an alternative to a power cord, the laptop computer may have a power port 122 arranged for either AC or DC supply. The laptop computer may comprise data transfer apparatus such as a data port 128 which may for example be compatible with a USB cable or a data port 130 or both. Although connections among the functional components of the laptop computer 110 are not shown as are corresponding connections in FIG. 1, it will be understood that these functional components are provided with electrical conductors, switches, and other apparatus necessary for operation as described herein.

It should be mentioned at this point that the transceiver 24 of the smart phone 10 and the 128 and 130 may be regarded as communications elements which may take the form of any one or more devices which are collectively capable of transmitting data remotely using a communications network, receiving data from a communications network, or both transmitting and receiving data remotely using a communications network. The communications capability may be for example among those which are commercially available to be communicably compatible with the internet or cellular telephone systems or both. In such cases, and as would apply to telephonic devices such as the smart phone 10 and to network compatible computers such as the laptop computer 110, it will be appreciated that the task may be communications related, for example, comprising processing data for subsequent transmission, processing data received from the communications network, or both.

FIGS. 1 and 2 illustrate two of many possible physical forms of electronic devices which may be utilized with the present invention. Regardless of the physical form of the electronic device, it will be provided with computer instructions loaded into the data handling apparatus, disposed to implement the task. Again, the task may be any ordinary function provided by the electronic device, in the course of implementation of which, data is processed. The electronic device is provided with computer instructions loaded into the data handling apparatus disposed to lock the screen such as the screens 16 or 116 responsive to a predetermined condition; and is provided with computer instructions loaded into the data handling apparatus, disposed both to unlock the screen and also to at least initiate implementation of the task responsive to entry of an input action by the user to the user input interface, such as the user interface 126, or the screen 16, where the latter is a touch screen displaying virtual controls. Examples of predetermined conditions which may lock the screen such as the screen 16 or 116 include inactivity for a predetermined time interval, and intentional locking by entry of a predetermined command for security purposes.

The task may be partially or fully implemented as part of the action which unlocks the screen such as the screen 16 or 116. For the purposes of this invention, at least initiating implementation of the task will be understood to signify that an input action, such as depressing one real or virtual key or pushbutton, causes the processor such as the processors 14 and 114 to advance towards at least partial completion of the task. At least initiating implementation may extend even to fully completing the task. In an illustrative example which could be associated with the smart phone 10, the task may be that of placing a voice protocol telephone call to a particular party whose telephone number has previously been loaded into the smart phone 10. In conventional schemes, and as referred to priorly, an exemplary path to completion of a corresponding task may require first unlocking the screen, then entering commands at various points along the path which culminates with the subject conventional telephone placing the call. One illustrative point along this path may include a step of opening a directory showing names or telephone numbers or both which are available from the memory of the conventional telephone. A prompt may be displayed, which prompt may require depression of a key or pushbutton to execute the step of displaying names or numbers. A second prompt may require depression of a key or pushbutton on a selected name or number. This second action may only designate the selection, and may possibly not execute the selected call, thereby requiring a third action, namely that of effecting the call.

In the present invention, and using the same sequence of steps as an illustration, proceeding past screen unlock to the first or second step along the path would constitute partial implementation of the task of placing the selected call. It would also be possible to proceed past screen unlock to the third step of effecting the call, thereby fully implementing the task.

This procedure may entail more than advancing directly from screen unlock to a necessary step along the path to completion, where the degree of implementation is limited to combining many conventionally necessary steps into one. Such a procedure would merely introduce an economy into the process. However, the procedure may advance past a choice, at which point conventional practice requires affirmative user input, without which user input progress would stop. An example of such a choice is selection of which party to call. A second example of choice is a decision whether to effect a conventional voice call, whether to transmit a pre-recorded message, or whether to select texting format. Some parties whose telephone numbers have been entered into memory may require a message affirming, negating, or modifying a standing instruction. For example, in a business environment, one may call a pre-established commercial source of business supplies, leaving a pre-recorded message to the effect that a typical monthly order for a particular supply, such as goods or services, is to be fulfilled without modification the following month. Alternatively, quantities or selections may be modified by predetermined arrangement. In this example, not only would the user of the smart phone 10 identify the party being called, but would also designate one of at least one prerecorded message to transmit. For other parties, a live call may be preferred. In the first example, using a conventional telephone scheme, a first choice, that of designating the party being called is made. Next, a second choice is made, that of designating which prerecorded message is to be transmitted. In the case of the live call, only designation of the party is necessary.

Therefore, the act of unlocking the screen 16 of the smart phone 10 could advance different degrees along the path to full implementation of the task, depending on which choices are to be made and which choices may be bypassed.

To summarize, the novel procedure not only introduces economizing steps, but may also advance past choices which otherwise would require affirmative selection by the user.

A corresponding operation may be conducted using an electronic device such as the laptop computer 110. Using the example of sending an email to a designated party, at least partial implementation of the task could signify that an email recipient is selected, with an empty window being displayed on the screen to enable a personalized message to be entered thereon. A full implementation could be selection and transmission of a predetermined message, such as that affirming that a standing order for supplies will indeed apply for the next month. The otherwise necessary step of choosing a party to contact, and in the example of selection of predetermined message, the otherwise necessary step of filling in the intended message, may both be bypassed.

In a further aspect of the invention, at least initiating implementation of the task may be responsive to entry of one and only one input action by the user. It should be understood that the one input action may literally require more than one haptic or physiological motion by the user. For example, in situations requiring entry of a multi-digit number such as a telephone number, Social Security number, or the like, several discrete depressions of a key or switch operator by finger may be required. However, the system which requires entry of the multi-digit number will not continue the process until the entire number has been entered. Some systems are sensitive to the number of digits entered, and will take further appropriate action responsive to entry of the requisite number of digits. Other systems require a separate command to act on entry of the entered digits. Regardless of the number of finger depressions or other physiological motions by the user or of the number of switch actions necessary, the one and only one action will be understood to include sufficient actions for the system of the electronic device to recognize and be able to proceed on the basis of the entered command This arrangement is different from an arrangement wherein a first user input action is not followed by a response by the electronic device requiring a subsequent user input action to enable the electronic device to recognize the input as a valid command, and to proceed responsively thereto.

The computer instructions which are loaded into the data handling apparatus and are disposed both to unlock the screen and also to at least initiate implementation of the task may comprises at least one user selectable command which may be entered using the user interface device. That is, rather than have the electronic device react to only one predetermined command mandated by the manufacturer of the electronic device, the electronic device may offer a plurality of commands. This becomes better understood with reference to the example of FIG. 3.

In FIG. 3, the screen 16 is seen to display two virtual sliders 30, 32 appearing thereon. The sliders 30, 32 may bear respective associated legends 34, 36 which identify the function of each slider 30 or 32. The upper slider 30 identifies a first party who may be contacted using the smart phone 10, and the second slider 32 launches navigation software provided by smart phone 10, which will provide directions to the address listed for a second party . Using either slider 30 or 32 may not only unlock the screen 16, but may also place a call to the party identified as John, or may enable GPS navigation to provide directions to the address of the party identified as Mary. In the example of FIG. 3, a first task would be that of calling John, and the second task that of navigating or receiving directions to Mary.

In summary, FIG. 3 illustrates a feature wherein the computer instructions loaded into the data handling apparatus, disposed both to unlock the screen and also to at least initiate implementation of the task are functional to respond to a plurality of user selectable commands which may be entered using the user interface device, and wherein each one of the user selectable commands both unlocks the screen and also at least initiates implementation of a different task independently of the existence of another user selectable command.

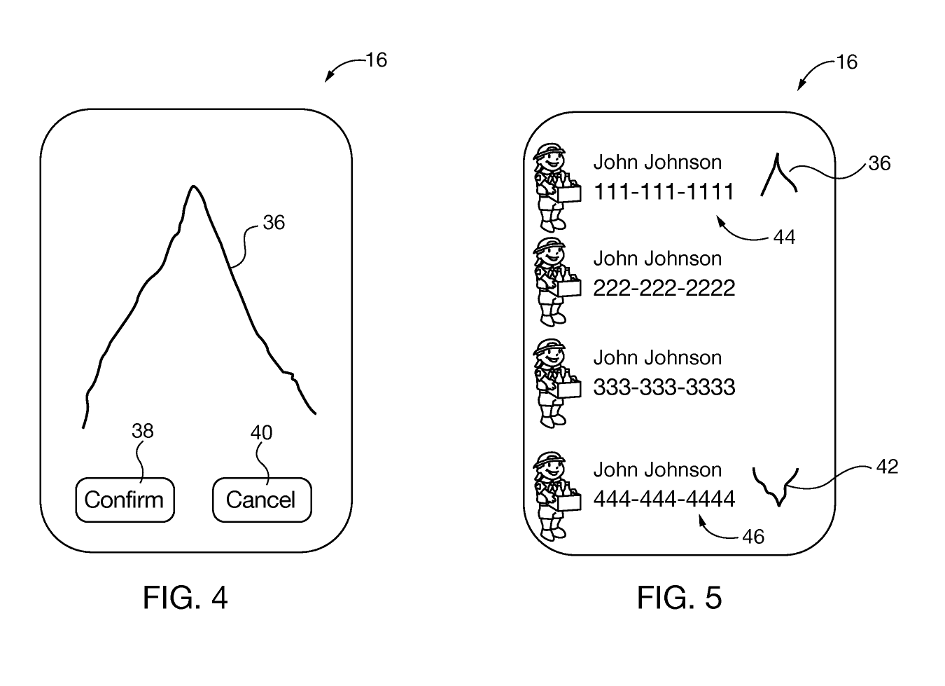

Referring to FIG. 4, it is possible not only to provide plural selectable user input commands which have been pre-established by the manufacturer and which may be presented for example as a menu, but also to enable the user to create his or her own user selectable commands. In FIG. 4, a personalized character in the form of a hand drawn image or character, such as a carat 36, has been drawn on the screen 16. This carat 36 may be entered into memory and designated as an authenticating icon which will be processed in subsequent entries and verified by a suitable image recognition program which may be part of the computer instructions loaded into the smart phone 10. The image recognition program is functional to recognize hand drawn characters to determine authentication of an authorized user, unlock the device, enable initiation of the task to proceed when authentication is determined, and to block initiation of the task when authentication is not determined. The image recognition program may store plural renderings of each entered image to assist in determining a match between an image being entered for authentication, and data available to the image recognition program for assessing that image being entered. Thus the system may have a library of images which may be used in “look-up” fashion for example.

Images may be uncomplicated geometric forms, for example including ovals, squares, triangles, and others. In one implementation of the invention, each image may be recorded in the library from ten samples.

After the carat 36 is entered onto the screen 16, a prompt such as the box 38 displaying the legend “confirm” may be activated to compete loading of the carat 36 into memory for subsequent use in authentication. It should be noted that the box 38 may be utilized not only in initial programming of accepted symbols for entry into memory, but may also be used to add to the library of symbols which have previously been designated as acceptable.

Alternatively, should the user decide not to use the carat 36 as drawn, he or she may elect to activate a prompt 40 which terminates the process of registering or recording the carat 36. This may be done to accommodate a user's judgment that the symbol was not properly drawn, or is better used in another way.

FIG. 5 illustrates programming the smart phone 10 to associate a given designated authenticating icon with one particular option. The various parties, telephone numbers, addresses, and other related information loaded into the data handling apparatus of the smart phone 10 may be displayed. A different icon may be established as being registered for any relevant information. In the example of FIG. 5, the carat 36 is being registered as that to be used to place a call to a first telephone number 44, and a “Vee” 42 is being registered as that to place a call to a second telephone number 46. The results of this registration procedure may result in initial screen contents such as shown for the screen 16 shown in FIG. 3, from which a selection may be made when first unlocking the screen 16 using registered gestures in FIG. 4. It will be seen from the contents of the screen 16 in FIG. 3 that a plurality of user selectable commands may be programmable by the user.

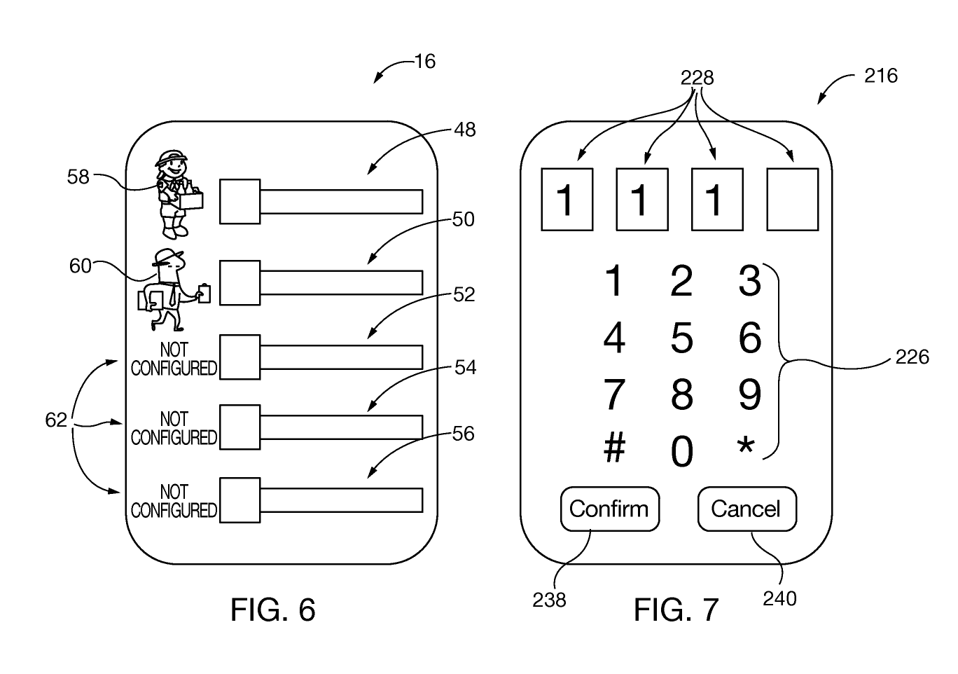

A further optional way of presenting a registration screen is seen in FIG. 6, wherein available virtual sliders 48, 50, 52, 54, 56 are available for configuring. As depicted in FIG. 6, the sliders 48, 50 have actually been configured, as indicated by icons 58, 60. The remaining sliders 52, 54, 56 are available for configuring in the future. This may be indicated by a legend such as the legend 62, which announces the “not configured” condition.

As an alternative to the use of sliders, such as the sliders 48 . . . 56, it would be possible either in a touchscreen device, such as the smart phone 10, or alternatively, with a device having actual keys, such as the user input interface 126 of the laptop computer 110 of FIG. 2, or virtual keys, to use entry of alphanumeric characters as a personal identification code. This option is shown in FIG. 7, which is a touchpad 216 displaying virtual keys 226, windows 228 to display entered characters, a box 238 displaying the legend “confirm”, and a prompt 240 displaying the legend “cancel” for terminating the action and starting anew. In this option, a user can register designated identification codes corresponding to any relevant information related to a user's contacts. Similar to using registered gestures as shortcuts, a user can user registered identification codes as shortcuts to performed designated tasks as well. It should be mentioned that similar functions may be implemented in a device having hard switches or keys, such as the laptop computer 110.

Whether hard switches or keys or virtual switches or keys are used, these switches may correspond to alphanumeric symbols. Alphanumeric symbols will be understood to encompass any or all know symbols, such as scientific symbols, astrological symbols, typographic symbols, alphabetical characters of non-Roman alphabets, and others. It will also be appreciated that service keys or switches such as power controlling switches, sound volume controls, camera operator buttons, and the like, may be incorporated into the pool of user operators which may be employed to establish a programmed command.

At least one of the user selectable commands may comprise a personalized sequence of alphanumeric symbols. That is, the selected command may utilize a user selected pattern of symbols. It would also be possible that the selected command comprise simultaneous operation of at least two different switches. If desired, the system may consider the time interval of depression of a key or other switch or command action.

After configuration of the initial screen, such as the screen 16 as seen in FIG. 3, or with a greater number of choices as seen in FIG. 5, the electronic device is ready for use.

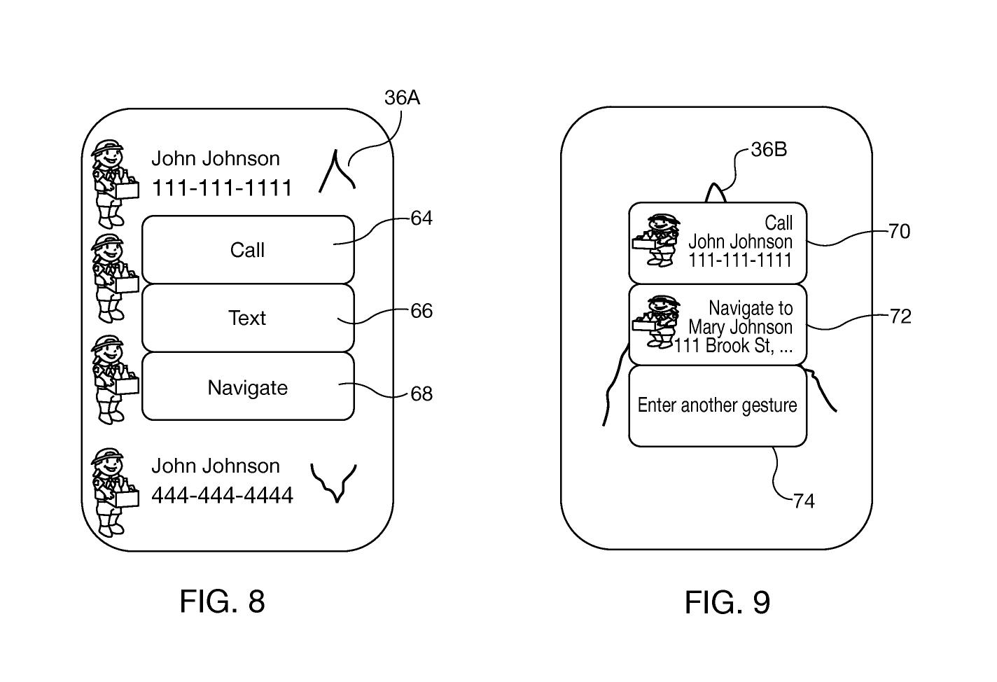

As seen in FIG. 8, entry of a screen unlocking operator, such as the carat 36A or the “Vee” 42A, may cause the electronic device to display prompts 64, 66, 68. This may arise for example should the screen unlocking operator not be previously programmed to select a specific action which is available. The choice may now be made using the appropriate prompt 64, 66, or 68.

FIG. 9 shows how an electronic device such as the smart phone 10 may accommodate failure to identify an entered image. In the example of FIG. 9, the user has entered a carat 36B. Should the image recognition program which has been loaded into the electronic device fail to match the entered carat 36B with any one image loaded into memory during programming of the electronic device, the system may respond by offering choices. These choices are seen as selectable prompts 70 and 72, which specify the option to call respectively a first party or a second party, whose contact data has been loaded into the data handling apparatus of the electronic device. If either of these choices is not satisfactory, the user may select a prompt 74, which returns the process to the point at which the user enters the hand drawn image, such as the carat 36. Should the redrawn character better match the archived examples of characters, implementation of the task may proceed.

It will be appreciated that whether a user selectable command to unlock the screen and to at least partially implement a task uses a single unlocking operator, such as either one of the sliders 30 or 32 of FIG. 3, or whether the user selectable command comprises use of at least two switches, such as the numeric code used in the example of FIG. 7, the user selectable commands may be programmable by the user and thus personal to the user.

Although explanation of the invention is set forth largely in terms of the smart phone 10, which is representative of mobile, hand held, communications capable devices, it will be apparent to those of skill in the art will recognize that the principles of the invention may be applied to all manner of hand held devices such as iPads and other tablets.

Reference to the various computer instructions loaded into the data handling apparatus need not imply permanent or exclusive residence of such computer instructions within the subject electronic device. Of course, the computer instructions could if desired reside permanently or exclusively in whole or in part within the electronic device as software or firmware for example. However, it would also be possible for the computer instructions to be provided or to operate remotely, such as from a remote computer or server (not shown) in whole or in part in at least partially implementing the selected task.

The particular features, structures, or characteristics described herein may be combined in any suitable manner in one or more implementations of the invention. Notably, although the example of the smart phone 10 is primarily intended to illustrate features of a device having a touch screen, and the example of the laptop computer 110 is intended to illustrate features of a device having physical switch controls, it would be possible for these features to appear in either type of device, and for both sets of features to appear in any one of these exemplary types of devices.

It will be understood by those skilled in the art that each function or operation or both as described herein can be implemented, individually and collectively or both, by a wide range of hardware, software, firmware, or virtually any combination thereof.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An electronic device which is capable of processing data and performing at least one task, comprising
data handling apparatus comprising memory and a data processor;
a display screen disposed to present imagery thereon and which is controlled by the data handling apparatus;
a user input interface usable by a user to enter at least one of commands and data to the data handling apparatus;
computer instructions loaded into the data handling apparatus, disposed to implement the task, in the course of which task implementation, data is processed;
computer instructions loaded into the data handling apparatus disposed to lock the screen responsive to a predetermined condition;
computer instructions loaded into the data handling apparatus, disposed both to unlock the screen and also to at least initiate implementation of the task responsive to entry of one and only one input action by the user.

2. The electronic device of claim 1, further comprising a communications element capable of at least one of the group consisting of transmitting data remotely using a communications network and receiving data from a communications network, and wherein the task comprises at least one of the group consisting of processing data for subsequent transmission and processing data received from the communications or navigation networks.

3. The electronic device of claim 2, wherein the communications element is communicably compatible with at least one of the internet and cellular telephone systems.

4. The electronic device of claim 1, wherein the computer instructions loaded into the data handling apparatus, disposed both to unlock the screen and also to at least initiate implementation of the task comprises at least one user selectable command which may be entered using the user interface device.

5. The electronic device of claim 4, wherein the user selectable command is programmable by the user.

6. The electronic device of claim 4, wherein the computer instructions loaded into the data handling apparatus, disposed both to unlock the screen and also to at least initiate implementation of the task is functional to respond to a plurality of user selectable commands which may be entered using the user interface device, and wherein each one of the user selectable commands both unlocks the screen and also at least initiates implementation of a different task.

7. The electronic device of claim 6, wherein the plurality of user selectable commands are programmable by the user.

8. The electronic device of claim 1, wherein the display screen comprises a touch screen, and wherein the electronic device further comprises computer instructions loaded into the data handling apparatus, disposed to accept manual inputs established by making contact with the touch screen, whereby the touch screen both displays imagery generated by the electronic device and also serves as the user input interface.

9. The electronic device of claim 8, wherein the user selectable command is a hand drawn character, and wherein the electronic device further comprises computer instructions loaded into the data handling apparatus which are functional to recognize hand drawn characters to determine authentication of an authorized user, enable initiation of the task to proceed when authentication is determined, and to block initiation of the task when authentication is not determined.

10. The electronic device of claim 8, wherein the user selectable command comprises at least one slider appearing on the display screen.

11. The electronic device of claim 10, wherein the user selectable command comprises a plurality of sliders appearing on the display screen, and wherein when operated, each one of the sliders unlocks the screen and at least initiates implementation of a different task.

12. An electronic device which is capable of processing data and performing at least one task, comprising
data handling apparatus comprising memory and a data processor;
a display screen disposed to present imagery thereon and which is controlled by the data handling apparatus;
a user input interface usable by a user to enter at least one of commands and data to the data handling apparatus, wherein the user input interface comprises a plurality of switches;
computer instructions loaded into the data handling apparatus, disposed to implement the task, in the course of which task implementation, data is processed;
computer instructions loaded into the data handling apparatus disposed to lock the screen responsive to a predetermined condition;
computer instructions loaded into the data handling apparatus, disposed both to unlock the screen and also to at least initiate implementation of the task responsive to entry of an input action by the user to the user input interface.

13. The electronic device of claim 12, wherein the at least one user selectable command is programmable by the user.

14. The electronic device of claim 12, further comprising a communications element capable of at least one of the group comprising transmitting data remotely using a communications network and receiving data from a communications network, and wherein the task comprises at least one of the group comprising processing data for subsequent transmission and processing data received from the communications network.

15. The electronic device of claim 14, wherein the communications element is communicably compatible with at least one of the internet and cellular telephone systems.

16. The electronic device of claim 16, wherein the computer instructions loaded into the data handling apparatus, disposed both to unlock the screen and also to at least initiate implementation of the task comprises a plurality of user selectable commands which may be entered using the user interface device.

17. The electronic device of claim 12, wherein the computer instructions loaded into the data handling apparatus, disposed both to unlock the screen and also to at least initiate implementation of the task is functional to respond to a plurality of user selectable commands each of which user selectable command comprises operating at least two switches of the user interface device, and wherein each one of the user selectable commands both unlocks the screen and also at least initiates implementation of a different task.

18. The electronic device of claim 17, wherein the plurality of user selectable commands are programmable by the user.

19. The electronic device of claim 12, wherein the plurality of switches corresponds to alphanumeric symbols, and wherein at least one of the user selectable commands comprises a personalized sequence of alphanumeric symbols.

20. The electronic device of claim 19, wherein at least one user selectable command comprises simultaneous operation of at least two different switches.
